(19) United States
(12) Patent Application Publication
(10) Pub. No.: US 2013/0237225 A1
(43) Pub. Date: Sep. 12, 2013

(54) ENHANCED MEMBERSHIP INDICATION FOR CLOSED SUBSCRIBER GROUP RADIO ACCESS NETWORK SHARING

(71) Applicant: Brian Alexander Martin, Farnham (GB)

(72) Inventor: Brian Alexander Martin, Farnham (GB)

(73) Assignee: RENESAS MOBILE CORPORATION, Tokyo (JP)

(21) Appl. No.: 13/414,550

(22) Filed: Mar. 7, 2012

(30) Foreign Application Priority Data
Mar. 6, 2012 (GB) 1203921.0

(51) Int. Cl. H04W 36/08; H04W 4/06

(52) U.S. Cl. 455/436

(57) ABSTRACT

A process is provided for a user equipment (UE) of a wireless network to determine if a serving network supports handover to a shared closed subscriber group (CSG) cell or not. In the radio resource signaling (RRC) procedures for handover, an information element (IE) may be added to downlink procedures to inform the UE if the network supports network sharing. Upon receipt of the IE the UE may make a determination to either continue the handover procedure to a shared cell or avoid handover to a non-shared cell. A corresponding apparatus and computer program product are also provided.

### CROSS-REFERENCE TO RELATED APPLICATIONS

This application claims priority under 35 U.S.C. §119(a) and 37 CFR 1.55 from United Kingdom Application No. 1203921.0 filed on Mar. 6, 2012, the entire content of which is hereby incorporated by reference.

### TECHNOLOGICAL FIELD

An example embodiment relates generally to communications technology and, more particularly, to cell handover procedures in mobile networks where the serving network supports handover to shared CSG cells.

### BACKGROUND

According to current practice, a mobile terminal, such as a user equipment (UE), which supports inbound mobility (e.g., handover, proximity indication, subscriber identity (SI) reading and reporting) to closed subscriber group (CSG) cells can only report the primary public land mobile network (pPLMN) broadcast by a CSG cell. In the future it is possible that CSG cells will support radio access network (RAN) sharing, therefore multiple PLMNs may be broadcast by the CSG cell(s), and the UE and the serving macro network (NW) would need to support enhanced mobility procedures to support handover to the additional PLMNs.

In networks which have not been upgraded to support handover to shared CSG cells, the meaning of “membership indication,” and “proximity indication” have been reported by the UE based on the any broadcast PLMN, however CSG Identification (ID) of the CSG cell in the UE whitelist (whitelist is the list of allowed CSG ID, PLMN stored in the UE) can be verified in the network based on the reported pPLMN only. It has been proposed that the UE reports all of the PLMNs that match the whitelist entries in the UE. However, it has not been considered what happens if the UE reports this to a legacy network that only expects a report for the primary PLMN. If the pPLMN does not match, and the UE reports a membership indication identifying the PLMN, a failed procedure can result. If the UE reports “membership indication” based on a PLMN ID other than the pPLMN, then the legacy network may misinterpret that and attempt to handover to the pPLMN, resulting in call drop in the worst case, or at least a handover request rejected by the target mobile management entity/service GPRS support node (MME/SGSN) (where GPRS is general packet radio service) due to membership check failing on the [pPLMN, CSG ID] particularly in the case of uncoordinated deployment of CSG cells.

### BRIEF SUMMARY

Various embodiments of a method, apparatus, and computer program product are provided for determining whether or not a serving mobile wireless network supports handover to a shared CSG cell, and includes the radio resource control (RRC) signaling and core network procedures to effect, or avoid, cell handover depending on the presence or absence of network support of handover to a shared CSG cell.

In one embodiment, a method of a wireless network entity comprises: causing during cell handover procedures, an information element (IE) to be provided in a downlink signal from a serving network node to be provided to indicate support of handover to a shared closed subscriber group (CSG) cell. The method may also include causing the network sharing IE to be provided in the downlink signal for configuring autonomous gaps, causing public land mobile networks (PLMNs) supported by the CSG cell to be provided in the system information downlink from the cell, receiving a PLMN membership response in an uplink signal from a mobile terminal (UE), selecting a PLMN for cell handover that is supported by the cell and the UE, receiving a PLMN membership response in an uplink signal from a mobile terminal (UE), and/or selecting a PLMN for cell handover that is supported by the cell and the UE.

Another embodiment is a method of a user equipment (UE) comprising: receiving during cell handover procedures an information element (IE) in a downlink signal from a serving network node to be provided to indicate support of handover to a shared closed subscriber group (CSG) cell. The method may also include receiving the IE indication of support of handover to a shared CSG cell in a cell in the downlink signal for configuring proximity indication, causing an identification to be provided in an uplink signal during cell handover procedures membership in one or more PLMNs supported by the cell that match a stored whitelist in the UE, and/or determining, after receipt of an IE showing that the serving network does not support handover to a shared CSG cell, to avoid handover by not performing radio resource control (RRC) signaling necessary to effect handover. The method may further comprise causing all PLMNs that match the stored UE whitelist to be matched and/or selecting a PLMN from multiple UE whitelist matching PLMNs based upon a priority determination. The selection of the PLMN may comprise selecting first the registered PLMN (rPLMN) when the rPLMN and CSG identification (CSG ID) in the UE whitelist are supported in the target cell, selecting second the home PLMN (HPLMN) when the HPLMN is part of the UE equivalent PLMN (ePLMN) and the HPLMN and CSG ID in the UE whitelist are supported by the target cell, selecting third the ePLMN when the ePLMN and CSG ID in the UE whitelist are supported by the target cell, and selecting fourth the ePLMN based on the broadcast order in the target cell when more than one ePLMN and CSG ID appear in the UE CSG whitelist.

An apparatus for wireless network communications is provided in one embodiment that comprises at least one processor and at least one memory including computer program code, the at least one memory and the computer program code configured to, with the processor, cause the apparatus to at least: cause, during cell handover procedures, an information element (IE) to be provided in a downlink signal from a serving network node to be provided to indicate support of handover to a shared closed subscriber group (CSG) cell, cause the network sharing IE to be provided in the downlink signal for configuring autonomous gaps, cause public land mobile networks (PLMNs) supported by the CSG cell to be provided in the systems information downlink from the cell, receive a PLMN membership response in an uplink signal from a mobile terminal (UE), and/or select a PLMN for cell handover that is supported by the cell and the UE. An alternative embodiment may be an apparatus for wireless network communications comprising at least one processor and at least one memory including computer program code, the at least one memory and the computer program code configured to, with the processor, cause the apparatus to at least: cause the network sharing IE to be provided in a downlink signal for configuring proximity indication, receive a PLMN membership response in an uplink signal from a mobile terminal (UE), and/or select a PLMN for cell handover that is supported by the cell and the UE.

Another embodiment may comprise an apparatus of user equipment in wireless communications comprising at least one processor and at least one memory including computer program code, the at least one memory and the computer program code configured to, with the processor, cause the apparatus to at least: receive during cell handover procedures an information element (IE) in a downlink signal from a serving network node to be provided to indicate support of handover to a shared closed subscriber group (CSG) cell. The at least one memory and the computer program code may also be configured to, with the processor, cause the apparatus to receive the IE indication of support of handover to a shared CSG cell in the downlink signal for configuring proximity indication, and/or cause in an uplink signal during cell handover procedures identification of membership in one or more PLMNs supported by the cell that match a stored whitelist in the UE. The apparatus may determine, after receipt of an IE showing that the serving network does not support handover to a shared CSG cell, to avoid handover by not performing radio resource control (RRC) signaling necessary to effect handover. If handover to a shared CSG cell is supported, the apparatus may cause all PLMNs that match the stored UE whitelist to be reported, and/or select a PLMN from multiple UE whitelist matching PLMNs based upon a priority determination. The at least one memory and the computer program code may be further configured to, with the processor, cause the apparatus to: select first the registered PLMN (rPLMN) when the rPLMN and CSG identification (CSG ID) in the UE whitelist are supported in the target cell, select second the home PLMN (HPLMN) when the HPLMN is part of the UE equivalent PLMN (ePLMN) and the HPLMN and CSG ID in the UE whitelist are supported by the target cell, select third the ePLMN when the ePLMN and CSG ID in the UE whitelist are supported by the target cell, and select fourth the ePLMN based on the broadcast order in the target cell when more than one ePLMN and CSG ID appear in the UE CSG whitelist.

A further embodiment may comprise a computer program product for a wireless network entity comprising at least one non-transitory computer-readable storage medium having computer-readable program instructions stored therein with the computer-readable program instructions comprising program instructions configured to cause, during cell handover procedures, an information element (IE) to be provided in a downlink signal from a serving network node to be provided to indicate support of handover to a shared closed subscriber group (CSG) cell. The computer program instructions may be further configured to cause the network sharing IE in the downlink signal for configuring autonomous gaps, causet public land mobile networks (PLMNs) supported by the CSG cell to be reported in the systems information downlink from the cell, receive a PLMN membership response in an uplink signal from a mobile terminal (UE), and/or select a PLMN for cell handover that is supported by the cell and the UE. The computer program product can further comprise program instructions configured to: cause the network sharing IE to be reported in a downlink signal for configuring proximity indication, receive a PLMN membership response in an uplink signal from a mobile terminal (UE), and/or select a PLMN for cell handover that is supported by the cell and the UE.

In another embodiment, a computer program product is provided for user equipment in a wireless network comprising at least one non-transitory computer-readable storage medium having computer-readable program instructions stored therein with the computer-readable program instructions comprising program instructions configured to: receive during cell handover procedures an information element (IE) in a downlink signal from a serving network node to be provided to indicate support of handover to a shared closed subscriber group (CSG) cell. The program instructions may be further configured to receive the IE indication of network sharing in the downlink signal for configuring proximity indication, and/or cause, in an uplink signal during cell handover procedures, an indication of membership in one or more PLMNs supported by the cell that match a stored whitelist in the UE. The computer program product may comprise program instructions to determine, after receipt of an IE showing that the serving network does not support handover to a shared CSG cell, to avoid handover by not performing radio resource control (RRC) signaling necessary to effect handover. The computer program product may further comprise program instructions configured to: select as first priority the registered PLMN (rPLMN) when the rPLMN and CSG identification (CSG ID) in the UE whitelist are supported in the target cell, select as second priority the home PLMN (HPLMN) when the HPLMN is part of the UE equivalent PLMN (ePLMN) and the HPLMN and CSG ID in the UE whitelist are supported by the target cell, select as third priority the ePLMN when the ePLMN and CSG ID in the UE whitelist are supported by the target cell, and select fourth the ePLMN based on the broadcast order in the target cell when more than one ePLMN and CSG ID appear in the UE CSG whitelist.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is an illustration of a system that may be configured to support a mobility procedure, such as a cell redirection or a handover, in accordance with an example embodiment of the present invention;

FIG. 2 is a block diagram of an apparatus that may be specifically configured in order to perform the operations in accordance with an example embodiment of the present invention;

FIG. 3 is a signaling diagram for a non-sharing network UE cell handover;

FIG. 4 is a signaling diagram for an example embodiment of a sharing network cell handover signaling protocol;

FIG. 5 is a signaling diagram for another example embodiment of a sharing network cell handover signaling protocol;

FIG. 6 is a flow diagram of an embodiment of a method disclosed for a wireless network entity;

FIG. 7 is a flow diagram of an embodiment of a method disclosed for a user equipment in a wireless network; and

FIG. 8 is a flow diagram of a further embodiment of a method disclosed for a user equipment in a wireless network.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As used in this application, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or application specific integrated circuit for a mobile phone or a similar integrated circuit in server, a cellular network device, or other network device.

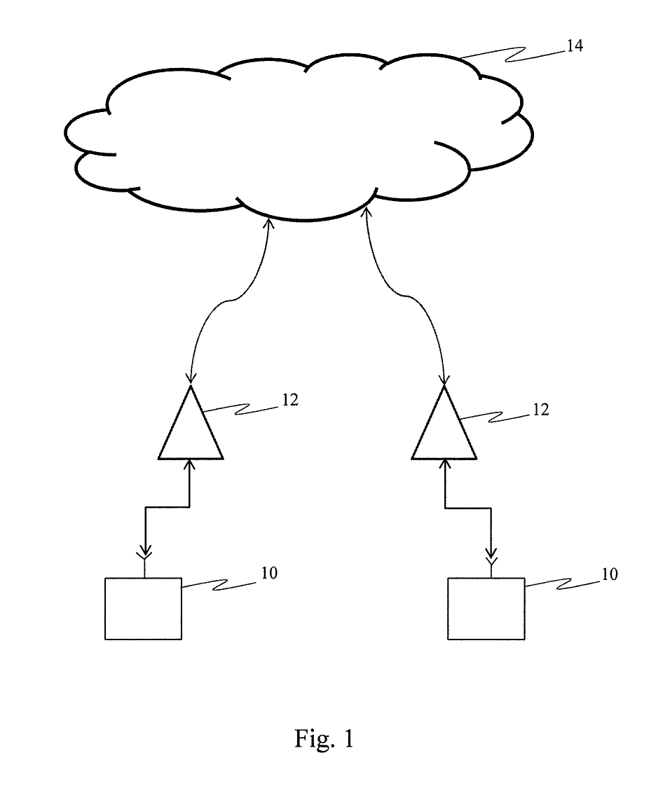

Referring to FIG. 1, a system that supports communications between user equipment (UE) 10 and a network 14, such as a Universal Mobile Telecommunications System (UMTS) network, a Long Term Evolution (LTE) network, an LTE-Advanced (LTE-A) network, a Global Systems for Mobile communications (GSM) network, a Code Division Multiple Access (CDMA) network, e.g., a Wideband CDMA (WCDMA) network, a CDMA2000 network or the like, a General Packet Radio Service (GPRS) network or other type of network, via a base station 12 is shown. Various types of user equipment may be employed including, for example, a mobile communication device such as, for example, a mobile telephone, portable digital assistant (PDA), pager, laptop computer, tablet computer, or any of numerous other hand held or portable communication devices, computation devices, content generation devices, content consumption devices, data cards, Universal Serial Bus (USB) dongles, or combinations thereof. Regardless of the type of user equipment, the user equipment may communicate with the network via a base station 12, such as a Node B, an evolved Node B (eNB), relay node or other type of access point.

The network 14 may include a collection of various different nodes, devices or functions that may be in communication with each other via corresponding wired and/or wireless interfaces. For example, the network may include one or more base stations, such as one or more node Bs, evolved node Bs (eNBs), access points, relay nodes or the like, each of which may serve a coverage area divided into one or more cells. For example, the network may include one or more cells, including a serving cell including, for example, the radio network controller (RNC) and one or more neighbor cells each of which may serve a respective coverage area. The serving cell and the neighbor cells could be, for example, part of one or more cellular or mobile networks or public land mobile networks (PLMNs). In turn, other devices such as processing devices (e.g., personal computers, server computers or the like) may be coupled to the mobile terminal and/or the second communication device via the network.

The UE (also termed mobile terminal) 10 may be in communication with each other or other devices via the network 14. In some cases, each of the communication terminals may include an antenna or antennas for transmitting signals to and for receiving signals from a base station. In some example embodiments, the mobile terminal 10 may be a mobile communication device such as, for example, a mobile telephone, portable digital assistant (PDA), pager, laptop computer, table computer, or any of numerous other hand held or portable communication devices, computation devices, content generation devices, content consumption devices, universal serial bus (USB) dongles, data cards or combinations thereof. As such, the mobile terminal 10 may include one or more processors that may define processing circuitry either alone or in combination with one or more memories. The processing circuitry may utilize instructions stored in the memory to cause the mobile terminal to operate in a particular way or execute specific functionality when the instructions are executed by the one or more processors. The mobile terminal may also include communication circuitry and corresponding hardware/software to enable communication with other devices and/or the network 14.

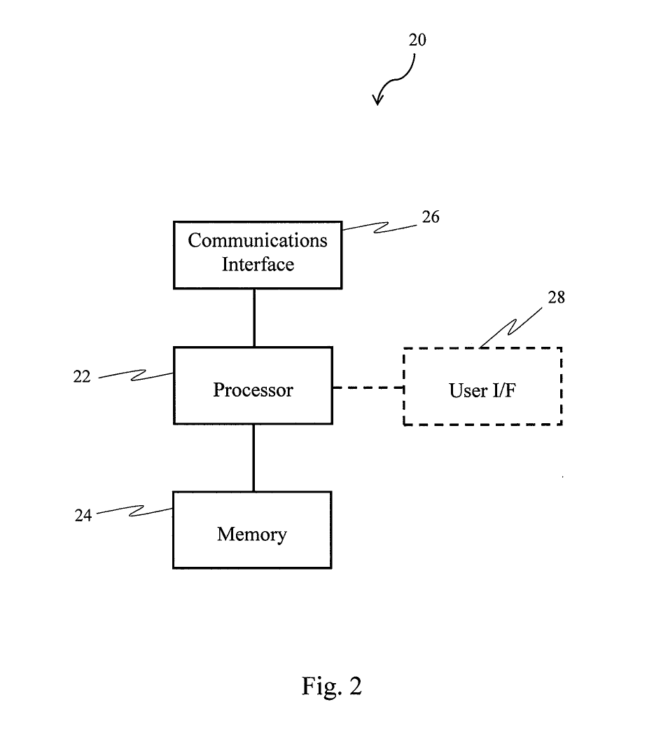

The mobile terminal 10 and a network entity, such as an RNC 12, may implement an example embodiment of the method, apparatus and computer program product in order to provide for an improved mobility procedure, such as a cell redirection or a handover. In this regard, the mobile terminal 10 and a network entity, such as the RNC 12, may each embody or otherwise be associated with an apparatus 20 that is generally depicted in FIG. 2.

As shown in FIG. 2, the apparatus 20 may include or otherwise be in communication with a processing system including processing circuitry, such as the processor 22 and, in some embodiments, the memory 24, that is configurable to perform actions in accordance with example embodiments described herein. The processing circuitry may be configured to perform data processing, application execution and/or other processing and management services according to an example embodiment of the present invention. In some embodiments, the apparatus or the processing circuitry may be embodied as a chip or chip set. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry may include a processor 22 and memory 24 that may be in communication with or otherwise control a communication interface 26 and, in some cases in which the apparatus is embodied by the mobile terminal 10, a user interface 28 (shown in dashed lines). As such, the processing circuitry may be embodied as a circuit chip (e.g., an integrated circuit chip) configured (e.g., with hardware, software or a combination of hardware and software) to perform operations described herein. However, in some embodiments taken in the context of the mobile terminal or a network entity, such as an RNC 12, the processing circuitry may be embodied as a portion of mobile terminal or the network entity.

The user interface 28 (if implemented in embodiments of the apparatus 20 embodied by the mobile terminal 10) may be in communication with the processing circuitry to receive an indication of a user input at the user interface and/or to provide an audible, visual, mechanical or other output to the user. As such, the user interface may include, for example, a keyboard, a mouse, a joystick, a display, a touch screen, a microphone, a speaker, and/or other input/output mechanisms. In one embodiment, the user interface includes user interface circuitry configured to facilitate at least some functions of the user equipment by receiving user input and providing output.

The communication interface 26 may include one or more interface mechanisms for enabling communication with other devices and/or networks. In some cases, the communication interface may be any means such as a device or circuitry embodied in either hardware, or a combination of hardware and software that is configured to receive and/or transmit data from/to a network 14 and/or any other device or module in communication with the processing circuitry, such as between the mobile terminal 10 and a network entity, such as an RNC 12. In this regard, the communication interface may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods.

In an example embodiment, the memory 24 may include one or more non-transitory memory devices such as, for example, volatile and/or non-volatile memory that may be either fixed or removable. The memory may be configured to store information, data, applications, instructions or the like for enabling the apparatus 20 to carry out various functions in accordance with example embodiments of the present invention. For example, the memory could be configured to buffer input data for processing by the processor 22. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 22 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory 24 or otherwise accessible to the processor. As such, whether configured by hardware or by a combination of hardware and software, the processor may represent an entity (e.g., physically embodied in circuitry—in the form of processing circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

The embodiments disclosed herein address a method, apparatus and computer program product for implementing enhanced mobile terminal mobility to CSG cells. Enhanced CSG membership indication in the signaling between the UE and a serving network is described. If a mobile network supports handover to a shared CSG cell, a mobile terminal may be acquired by a shared cell and the UE communication may proceed over one of a pPLMN or an alternative PLMN that matches the UE whitelist (stored in the UE). The UE can also use the indication of support of handover to a shared CSG cell—or lack of it—as a screening tool, avoiding handover to non-shared CSG cells.

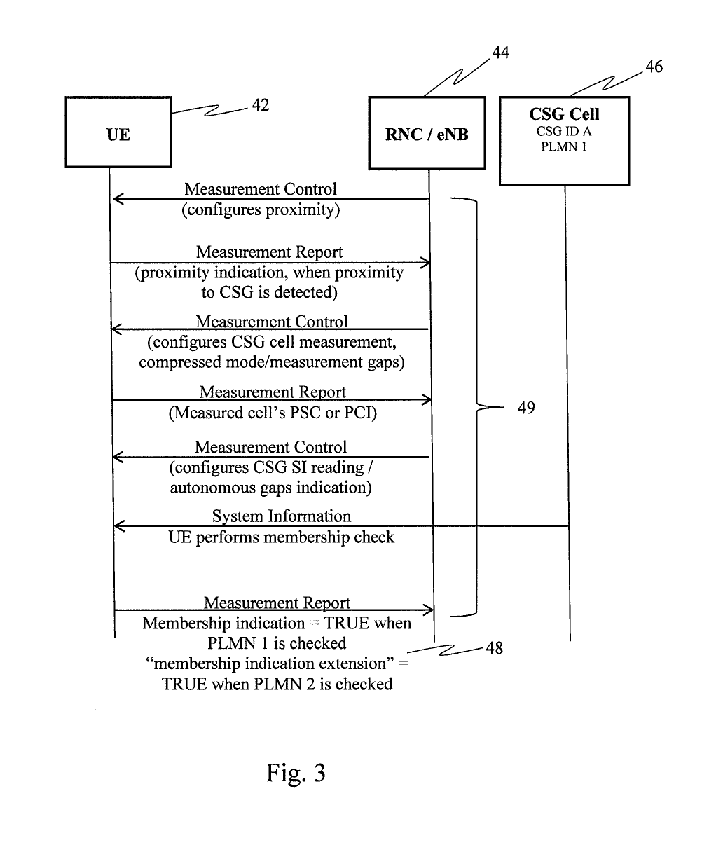

Referring to FIG. 3, an RRC signaling diagram for a legacy network, not upgraded for handover to a shared CSG cell, is illustrated. The elements that interact to connect a mobile terminal to a serving network through a cell are the UE 42, the network controller (RNC)/eNB 44, and a CSG cell 46. In the example of FIG. 3, the UE 42 has whitelist entry for either [CSG ID A, PLMN1] or [CSG ID A, PLMN 2]. The CSG ID identifies to which closed subscriber group the UE subscribes and enables the UE to be identifiable as it attempts to gain access to the network; the PLMN is the network identifier. The cell handover signaling procedure, shown in FIG. 3, is familiar to those skilled in the art. It is significant to note that throughout the sequence 49 there is no indication whether the network is capable of handover to a shared CSG cell or not. The UE must perform all of the signaling procedure in order to report CSG membership 48 even if the network does not support handover to a shared CSG cell. The uplink non-critical extension sent by the UE in case of PLMN2 membership 48 will be discarded by the network in this example of RRC signaling for a non-shared cell.

Regarding the last signal 48 shown in FIG. 3, UE always has to set membership status. For PLMN2 the signaling needs to be extended to have a second (separate) membership indication decodable only by a network supporting the feature. If both PLMNs result in a successful check, then both PLMNs and membership indications need to be reported. In order to avoid interoperability problems (with networks not upgraded to support handover to a shared CSG cell), the membership status of any PLMN which is not the primary PLMN needs to be reported using a non-critical extension 48. Even in case the serving network supports handover to a shared CSG cell, the fact that the different PLMNs are reported via different information elements (IEs) will require more complex handling in the RNC/eNB 44 (or other network node, depending on implementation) and impacts the uplink signaling structure in FIG. 3 such that encoding in UE side may also be more complex).

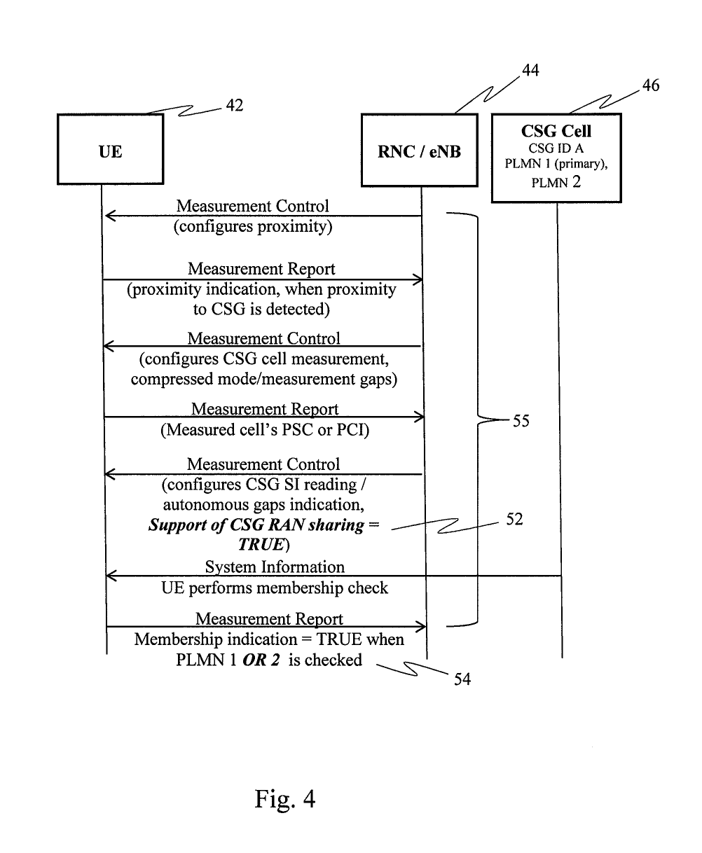

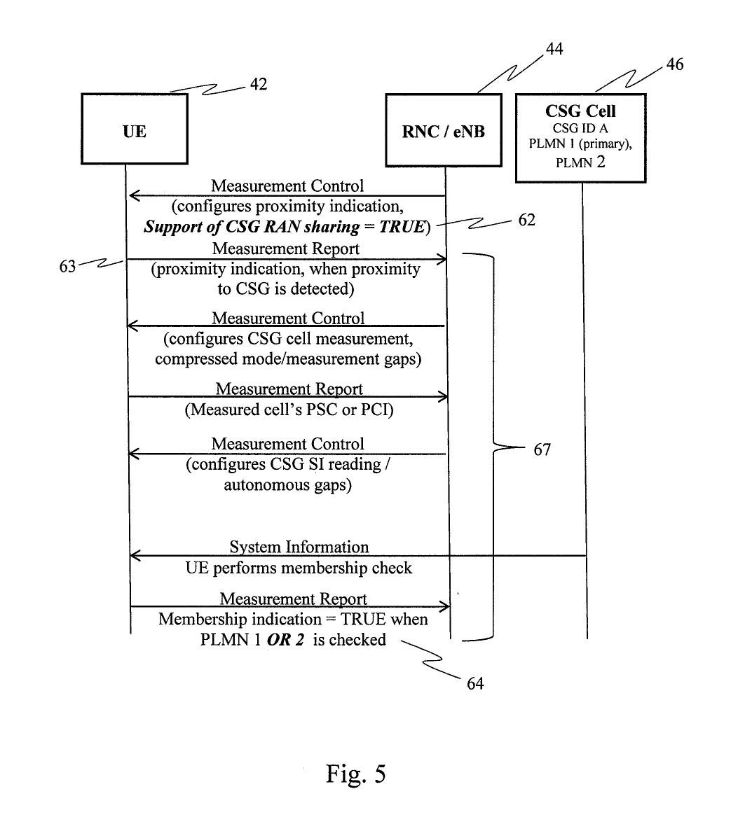

In alternative example embodiments, the serving network RNC may add an information element (IE), such as a 1-bit IE, to the downlink message configuring either “proximity indication” measurement (FIG. 5 illustration), or when configuring the “SI reading measurement” (See FIG. 4) (in LTE this is known as ‘si-RequestForHO’ and in UMTS it is known as “SI acquisition”). If the NW indicates that handover to a shared CSG cell is supported (e.g. with an “on” flag, indicating support), then the UE reports its membership indication based on any PLMN. If the NW does not indicate support of handover to a shared CSG cell (e.g. a legacy NW) then the UE reports membership indication only for its primary PLMN (pPLMN).

Based on whether the UE receives the 1 bit indication or not, then the UE either sets the “membership indication” only according to pPLMN, or according to any PLMN broadcast by the cell. If based on any PLMN in the cell, then the UE also reports the PLMN(s) which causes the membership indication to be true. The same IE in the uplink “membership indication” is used regardless of whether the network is legacy or upgraded for handover to a shared CSG cell. If the 1 bit IE from the network is sent when configuring proximity indication (FIG. 5), then it's possible for the UE to take into account, when making the decision to send proximity indication, whether the NW supports handover to shared CSG cell, and also whether the PLMN which the UE believes to match its whitelist is a primary PLMN of the cell, or not.

Referring to FIG. 4, it is possible to re-use the existing measurement/report message encoding (FIG. 3) entirely, with signaling modification only in the downlink message to the UE 42 which configures the SI reading procedure 52. Again in the FIG. 4 example, the UE 42 has whitelist entries for either [CSG ID A, PLMN1] or [CSG ID A, PLMN 2] (that is, it may be handed over to a cell that is shared by mobile networks PLMN1 or PLMN2). If the serving NW 44 indicates that handover to a shared CSG cell is supported (e.g. with “on” flag, indicating support) 52, then the UE reports membership indication 54 based on any PLMN supported by the CSG cell and matching the UE whitelist. Alternatively, if the serving NW 44 does not indicate support of handover to a shared CSG cell (e.g. it is a legacy NW), then the UE 42 reports a membership indication only for its pPLMN; there would be no need for an indication regarding PLMN 2. This allows a more generic implementation in the node B 44, thereby avoiding an interoperability problem with less complexity. However, the entire signaling procedure 55 is still needed to determine UE membership status.

Referring to FIG. 5 an alternative embodiment is illustrated. In this example implementation, again the UE 42 has a whitelist entry for either [CSG ID A, PLMN1] or [CSG ID A, PLMN 2]. This time the indication of NW 44 support of handover to shared CSG cells is included early in the handover process, such as when proximity indication 62 is configured. The UE 42 of this embodiment is immediately advised whether handover to a shared CSG cell is supported and it can proceed with the necessary configurations and report membership 64 in PLMN 1 or PLMN 2 (or any other) for network communication. Again if no indication of support of handover to a shared CSG cell is received, the UE reports only its pPLMN membership.

It is possible to further optimize the UE 42 behavior in that it may be able to avoid sending the proximity indication 63 if the PLMN is known not to be the primary one and the serving NW does not support handover to another PLMN than the primary one. If the UE 42 avoids sending the proximity indication then it does not need to perform radio resource control (RRC) signaling, measurements, and system information reading 67 of the CSG cell in order to verify that the CSG cell is allowed due to matching a PLMN (with CSG ID) which is not the primary PLMN of the CSG cell. In brief, the UE can simply wait for proximity to another CSG cell and avoid running through the RRC protocol 67 of FIG. 5. This reduces RNC 44 signaling load and avoids excessive power consumption in the UE 42.

It is also possible to implement a UE which is not optimized in the proximity indication behavior described above (e.g. a simpler UE implementation). In this case, the UE does not take into account whether or not the PLMN is primary and sends the proximity indication regardless of that aspect. As illustrated in FIG. 5, the UE simply completes the handover signaling exchange, reporting membership 64 in PLMNs that match the CSG network sharing capability and the UE whitelist.

To support the proposed embodiments, the UE needs to additionally report which PLMN reported to be supported by the candidate cell has matched the whitelist. There are at least two alternatives:

1) Report all PLMNs which match; or

2) Prioritize the PLMNs and report the highest priority PLMN.

In an instance in which the PLMNs are prioritized, the UE may select the PLMN based on following priority order:
First, if the registered PLMN (rPLMN) of the UE broadcast in the target cell and the rPLMN and CSG ID broadcasted in the target cell is found in the UE CSG whitelist, UE selects the rPLMN. Next, in an instance in which the rPLMN is not selected, if the UE's home PLMN (HPLMN) is broadcast in the target cell and the HPLMN is part of UE's equivalent PLMN (ePLMN) and the HPLMN and CSG ID is broadcasted in the target cell in UE CSG whitelist, then UE selects the HPLMN. Next, when neither the rPLMN nor the HPLMN is selected, if one of UE's ePLMN is broadcast in the target cell and the ePLMN and CSG ID broadcasted in the target cell is in UE CSG whitelist, UE selects the ePLMN. Finally, in an instance in which the rPLMN, HPLMN and ePLMN have not yet been selected, if more than one ePLMN and CSG ID appears in the UE CSG Whitelist, UE selects the ePLMN based on the broadcasted order.

For LTE, the measurement report can already contain a PLMN ID, hence the uplink signaling does not need to be modified. For UMTS, an extension may be added in one embodiment to include PLMN ID. Regardless, the membership indication meaning remains unchanged when communicating with a legacy network, but the meaning may differ when communicating with a upgraded network.

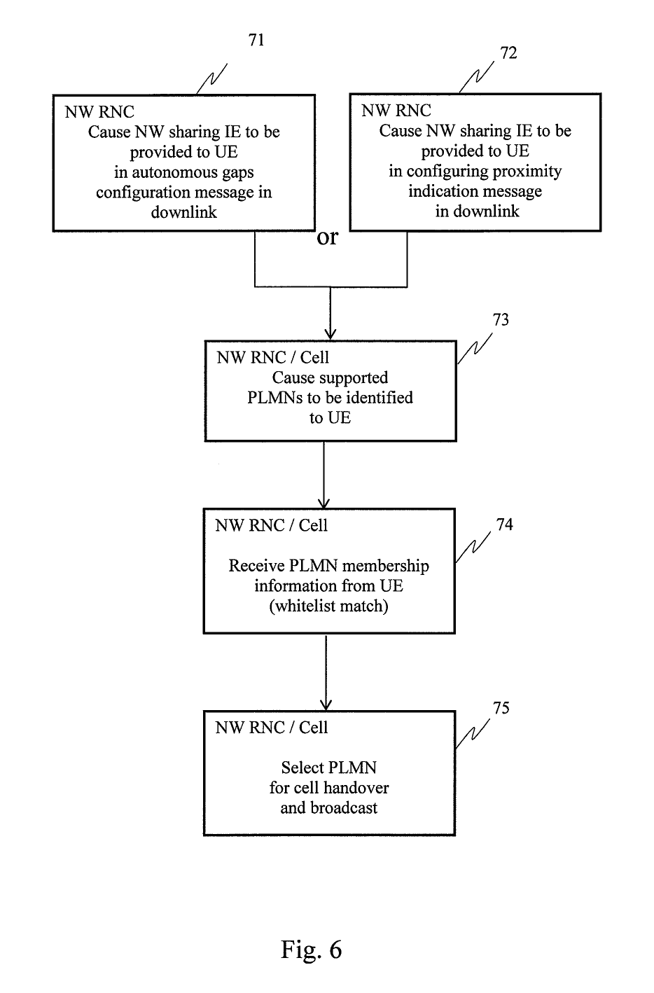

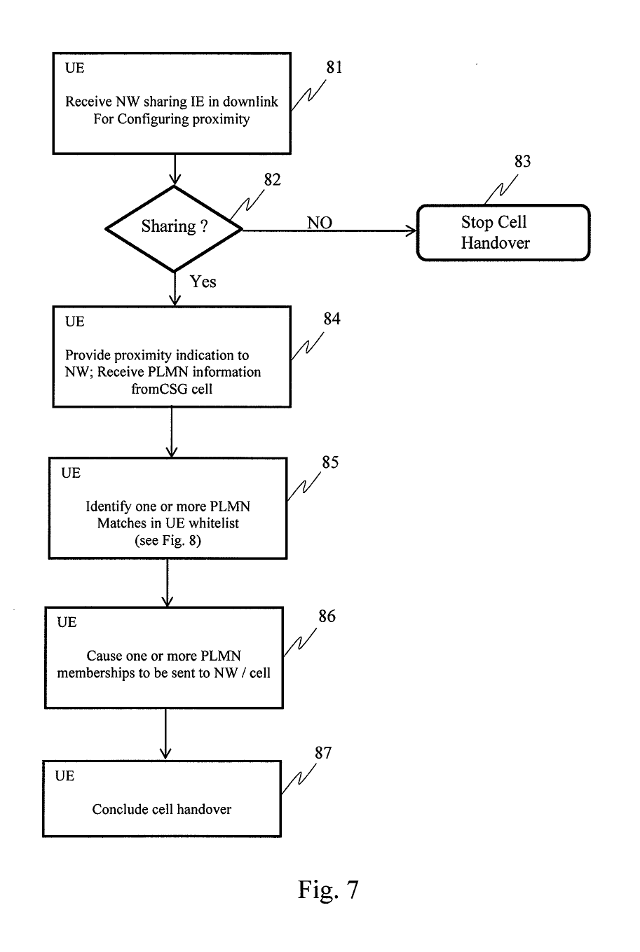

A sequence of flow charts illustrate the processes that can be implemented on the network side and the UE side respectively of the cell handover procedure where the network may support shared network communication and certain legacy networks that do not. Referring to FIG. 6, alternative network procedures are shown. An apparatus embodied by a serving network node, such as the RNC, may include means, such as the processor, communications interface or the like, for causing an information element (IE) indicating the presence of network sharing capability to be reported in the “autonomous gaps” configuration downlink during cell handover. See block 71. The apparatus embodied by one network node, such as one RNC, may also include means such as one processor, communications interface or the like, for causing supported PLMNs to be identified to the UE. See block 73. The apparatus embodied by one UE may, in turn, include means, such as one processor or the like, for comparing them to its whitelist of PLMN/CSG IDs stored in the UE. In an uplink transmission, the apparatus embodied by an RNC may include means such as the processor, communications interface or the like, to receive PLMN membership information from the UE, the result of the UE comparing its whitelist to the cell's supported PLMN(s). See block 74. The apparatus embodied by an RNC may include means such as the processor to establish a PLMN for cell handover. See block 75. Should the apparatus embodying an RNC report, through means such as its processor and communications interface or the like, the IE indicating the presence of shared network capability in the cell in the “configuring proximity” downlink (at the very start of handover procedures) the sequence continues to the identification of membership PLMN as shown. However, as is illustrated in FIG. 7, should the IE indicate no support of handover to a shared CSG cell, the UE may respond quite differently.

Referring to FIG. 7, an embodiment of the sequence is shown from the perspective of an apparatus embodying means for communicating with a network node RNC, which may comprise at least a processor and a communications interface or the like, such as a UE. This example shows the alternatives for when in the handover procedures the IE for CSG cell sharing may be delivered to an embodiment such as a UE, which may comprise means such as a processor and communications interface or the like. The CSG cell sharing IE may be added to the “autonomous gaps configuration” downlink sent from an apparatus embodied by the RNC, which may include means such as a processor and communications interface or the like. See block 81. However, to permit flexibility in the UE response, the sharing IE may be reported in the “configuring proximity” downlink 81 of the handover procedures. The apparatus embodying the UE can then make a decision based on the presence or absence of support of handover to a shared CSG cell. See block 82. If sharing is reported, the apparatus embodying the UE goes through the handover sequence. The apparatus embodying the UE, through means such as its communications interface and processor or the like, reports a proximity indication to the network, then receives PLMN information from the cell. See block 84. The UE apparatus, which may comprise means such as a processor and a memory, matches the cell PLMN to the UE whitelist. See block 85. The apparatus embodied by the UE, through means such as its communications interface, sends PLMN membership information to the network. See block 86. The apparatus embodying the network node and the UE then conclude handover. See block 87. However, if sharing is not indicated, the apparatus embodying the UE can be configured, through means such as its processor, memory, and computer code instructions, to avoid handover to the subject cell altogether, saving signaling overhead and preventing needless power consumption. See block 83.

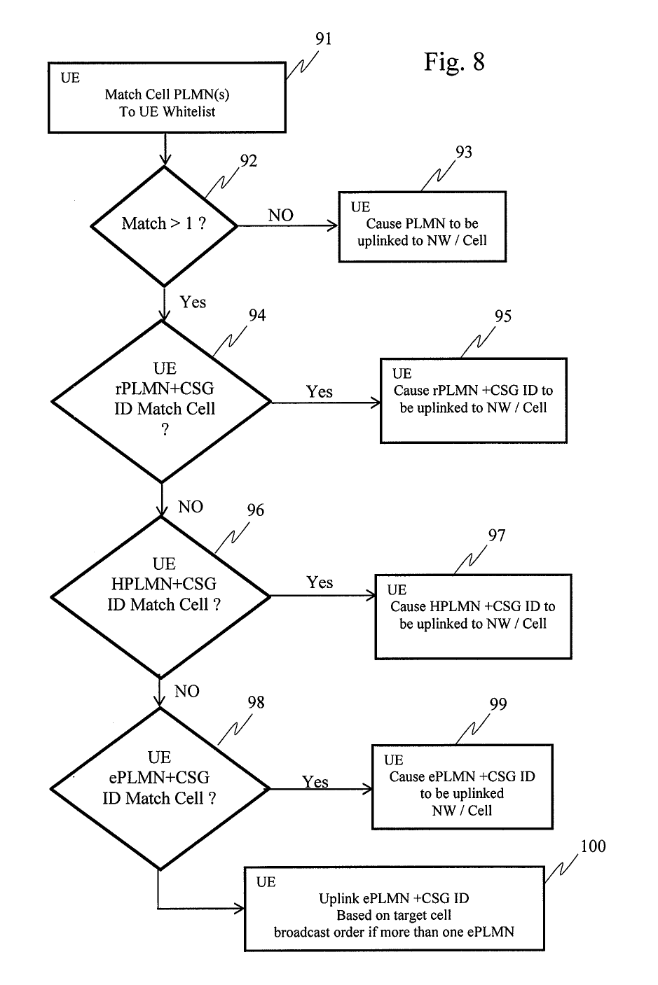

FIG. 8 illustrates the hierarchy of PLMN selection when the cell PLMNs match 91 more than one entry in the UE whitelist, which may include means such as a processor and memory or the like. The apparatus of the UE, which may include means such as a processor, memory and communications interface, compares the PLMN identified by the CSG cell with the whitelist of CSG IDs and PLMNs stored in the UE memory. See block 91. If the apparatus embodying the UE discovers one matching PLMN in the UE whitelist, that simply results in the matching PLMN being uplinked to the network controller through means such as a processor and communications interface in the UE. See block 93. If there is more than one match the UE goes through a priority selection sequence. First the apparatus of the UE, through means such as a processor and memory or the like, checks for a match with its registered PLMN (rPLMN). See block 94. If that matches then the apparatus of the UE, through means such as the processor and communications interface or the like, choose the rPLMN for the handover. See block 95. If not, the apparatus of the UE checks, using means such as a processor or memory or the like, for a match with its HPLMN, see block 96, and reports through means such as a communications interface if that match is successful. See block 97. The next check conducted by a UE apparatus, through means such as a processor and memory or the like, is for an equivalent PLMN (ePLMN). See block 98. A match is reported by the apparatus embodying the UE, through means such as a processor and communications interface or the like, in an uplink if the ePLMN matched. See block 99. Finally, the apparatus embodying the UE, through means such as a processor and communications interface or the like, uplinks an ePLMN that matches the target cell's broadcast order where it can use more than one ePLMN. See block 100.

The example embodiments for identifying and connecting UE to shared CSG cells when serving networks support handover to a shared CSG cell have several advantages over the current protocol (for non-shared network CSG cells). The backwards compatibility issue is resolved in one of two ways. First, if the UE does not receive a handover to a shared CSG cell indicator IE, the UE can report only membership in its pPLMN. Alternatively, if the UE does not receive the CSG cell sharing indicator IE it can stop the signaling protocol for establishing a link with a subject cell and avoid the cell altogether. Next, there is little impact on the signaling protocol to inform a UE of a shared network and for the UE to return its PLMN membership information to the RNC, while providing a simple process for locating and communicating through a shared network cell. And, configuring the UE to avoid non-shared network cells reduces signaling overhead and simultaneously reduces the power consumption overhead.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

That which is claimed:

1. A method comprising:
during cell handover procedures, causing an information element (IE) in a downlink signal from a serving network node to be provided to indicate support of handover to a radio access network (RAN) shared closed subscriber group (CSG) cell.

2. The method of claim 1 further comprising:
causing the network sharing IE in the downlink signal to be provided in the downlink signal for one of configuring autonomous gaps or configuring proximity indication.

3. The method of claim 2 further comprising:
causing public land mobile networks (PLMNs) supported by the CSG cell to be reported in the systems information downlink from the CSG cell.

4. The method of claim 3 further comprising:
receiving a CSG membership response in an uplink signal from a mobile terminal (UE); and selecting a PLMN for cell handover that is supported by the cell and the UE.

5. A method comprising:
receiving during cell handover procedures an information element (IE) in a downlink signal from a serving network node to be provided to indicate support of handover to a radio access network (RAN) shared closed subscriber group (CSG) cell.

6. The method of claim 5 further comprising:
receiving an IE indication of network sharing in a cell in the downlink signal for one of configuring autonomous gaps or configuring proximity indication.

7. The method of claim 6 further comprising:
causing an indication to be provided in an uplink signal during cell handover procedures of CSG membership in one or more PLMNs supported by the cell that match a stored whitelist in the UE.

8. The method of claim 7 further comprising:
determining, after receipt of an IE showing that the serving network does not support handover to a shared CSG cell, to avoid handover by not performing radio resource control (RRC) signaling and/or measurements necessary to effect handover.

9. The method of claim 7 further comprising:
causing all PLMNs to be reported that match the stored UE whitelist.

10. The method of claim 7 further comprising:
selecting a PLMN from multiple UE whitelist matching PLMNs based upon a priority determination.

11. The method of claim 10 further comprising:
selecting first a registered PLMN (rPLMN) when the rPLMN and CSG identification (CSG ID) in the UE whitelist are supported in a target cell; selecting second a home PLMN (HPLMN) when the HPLMN is part of a UE equivalent PLMN (ePLMN) and the HPLMN and CSG ID in the UE whitelist are supported by a target cell; selecting third the ePLMN when the ePLMN and CSG ID in the UE whitelist are supported by a target cell; and selecting fourth the ePLMN based on the broadcast order in the target cell when more than one ePLMN and CSG ID appear in the UE CSG whitelist.

12. An apparatus for wireless network communications comprising at least one processor and at least one memory including computer program code, the at least one memory and the computer program code configured to, with the processor, cause the apparatus to at least:
during cell handover procedures, cause an information element (IE) to be provided in a downlink signal from a serving network node to indicate support of handover to a radio access network (RAN) shared closed subscriber group (CSG) cell.

13. The apparatus of claim 12 wherein the at least one memory and the computer program code are further configured to, with the processor, cause the apparatus to:
cause the network sharing IE to be provided in the downlink signal for one of configuring autonomous gaps or configuring proximity indication.

14. The apparatus of claim 13 wherein the at least one memory and the computer program code are further configured to, with the processor, cause the apparatus to:
cause public land mobile networks (PLMNs) supported by the CSG cell to be reported in the systems information downlink from the CSG cell.

15. The apparatus of claim 14 wherein the at least one memory and the computer program code are further configured to, with the processor, cause the apparatus to:
receive a CSG membership response in an uplink signal from a mobile terminal (UE); and select a PLMN for cell handover that is supported by the cell and the UE.

16. An apparatus according to claim 12 wherein the apparatus is embodied by the network node.

17. An apparatus of user equipment in wireless communications comprising at least one processor and at least one memory including computer program code, the at least one memory and the computer program code configured to, with the processor, cause the apparatus to at least:
receive during cell handover procedures an information element (IE) in a downlink signal from a serving network node to be provided to indicate support of handover to a radio access network (RAN) shared closed subscriber group (CSG) cell.

18. The apparatus of claim 17 wherein the at least one memory and the computer program code are further configured to, with the processor, cause the apparatus to:
receive the IE indication of network sharing in a cell in the downlink signal for one of configuring autonomous gaps or configuring proximity indication.

19. The apparatus of claim 18 wherein the at least one memory and the computer program code are further configured to, with the processor, cause the apparatus to:
identify in an uplink signal during cell handover procedures CSG membership in one or more PLMNs supported by the cell that match a stored whitelist in the UE.

20. The apparatus of claim 18 wherein the at least one memory and the computer program code are further configured to, with the processor, cause the apparatus to:
determine, after receipt of an IE showing that the serving network does not support handover to a shared CSG cell, to avoid handover by not performing radio resource control (RRC) signaling and/or measurements necessary to effect handover.

21. The apparatus of claim 19 wherein the at least one memory and the computer program code are further configured to, with the processor, cause the apparatus to:
cause all PLMNs to be reported that match the stored UE whitelist.

22. The apparatus of claim 19 wherein the at least one memory and the computer program code are further configured to, with the processor, cause the apparatus to:
select a PLMN from multiple UE whitelist matching PLMNs based upon a priority determination.

23. The apparatus of claim 22 wherein the at least one memory and the computer program code are further configured to, with the processor, cause the apparatus to:
select first a registered PLMN (rPLMN) when the rPLMN and CSG identification (CSG ID) in the UE whitelist are supported in a target cell; select second a home PLMN (HPLMN) when the HPLMN is part of a UE equivalent PLMN (ePLMN) and the HPLMN and CSG ID in the UE whitelist are supported by a target cell; select third the ePLMN when the ePLMN and CSG ID in the UE whitelist are supported by a target cell; select fourth the ePLMN based on the broadcast order in the target cell when more than one ePLMN and CSG ID appear in the UE CSG whitelist.

24. An apparatus according to claim 17 wherein the apparatus is embodied by a mobile telephone.

25. A computer program product embodied on a non-transitory computer readable medium comprising a set of program instructions, which, when executed on a wireless network entity, cause the network entity to perform the steps of:
providing during cell handover procedures an information element (IE) to be provided in a downlink signal from a serving network node to indicate support of handover to a radio access network (RAN) shared closed subscriber group (CSG) cell; causing public land mobile networks (PLMNs) supported by the CSG cell to be reported in the systems information downlink from the CSG cell; receiving a CSG membership response in an uplink signal from a mobile terminal (UE); selecting a PLMN for cell handover that is supported by the cell and the UE.

26. A computer program product according to claim 25 wherein the computer-readable program instructions further cause the user equipment to perform the steps of:
causing the network sharing IE to be provided in a downlink signal for one of configuring autonomous gaps or configuring proximity indication.

27. A computer program product embodied on a non-transitory computer readable medium comprising a set of program instructions, which, when executed on a user equipment cause the user equipment to perform the steps of:
receiving during cell handover procedures an information element (IE) in a downlink signal from a serving network node to be provided to indicate support of handover to a radio access network (RAN) shared closed subscriber group (CSG) cell; identifying in an uplink signal during cell handover procedures CSG membership in one or more PLMNs supported by the cell that match a stored whitelist in the UE.

28. A computer program product according to claim 27 wherein the computer-readable program instructions further cause the user equipment to perform the steps of:
determining, after receipt of an IE showing that the serving network does not support handover to a shared CSG cell, to avoid handover by not performing radio resource control (RRC) signaling and/or measurements necessary to effect handover.
